(19) United States
(12) Patent Application Publication
(10) Pub. No.: US 2010/0079689 A1
(43) Pub. Date: Apr. 1, 2010

(54) LIQUID CRYSTAL MOLECULE, LIQUID CRYSTAL DISPLAY DEVICE AND LIQUID CRYSTAL OPTICAL SPATIAL MODULATION DEVICE

(75) Inventors: Ken Kobayashi, Kanagawa (JP); Hidehiko Takanashi, Kanagawa (JP); Rika Kotake, Kanagawa (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 12/568,843

(22) Filed: Sep. 29, 2009

(30) Foreign Application Priority Data
Sep. 30, 2008 (JP) 2008-253312

(51) Int. Cl. G02F 1/133; C07F 7/10

(52) U.S. Cl. 349/33; 556/418

(57) ABSTRACT

A liquid crystal molecule is disclosed, having a structure represented by the following general formula (1):

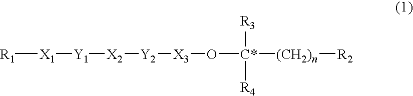

wherein
X₁ is represented by the following formula (2), and a dangling bond to R₁ is arbitrary:

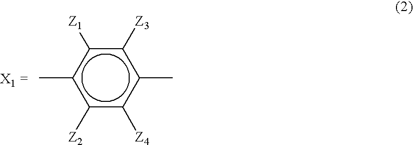

X₂ is a group selected among groups represented by the following formula (3):

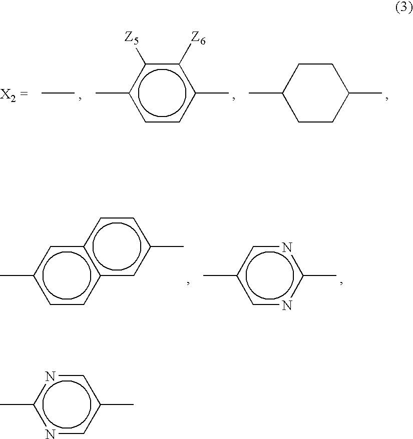

X₃ is represented by the following formula (4):

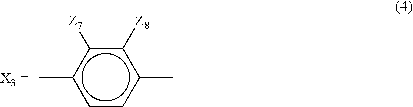

R₁ represents a linear or branched hydrocarbon group or an alkoxy group each having from 4 to 16 carbon atoms;
R₂ represents an optionally branched organosiloxane or organosilane having from 1 to 6 silicon atoms;
R₃ and R₄ are different from each other and each represents H, F, Cl, Br, CN, CH₃, CF₃ or OCH₃;
Y₁ and Y₂ each represents -, —COO—, —CH₂—, —CH₂O—, —C₂H₂—, —C₂— or —CF₂O—;
Z₁ and Z₂ each represents F, Cl, Br, OH, NO₂, CN or CF₃;
Z₃ and Z₄ each represents H, F, Cl, Br, OH, NO₂, CN or CF₃;
Z₅ and Z₆ each represents H, F, Cl, Br, OH, NO₂, CN or CF₃;
Z₇ and Z₈ each represents H, F, Cl, Br, OH, NO₂, CN or CF₃, provided that Z₇ and Z₈ do not represent H at the same time;
n represents an integer of from 1 to 6;
* represents a chiral center; and
- means a connecting group.

### BACKGROUND OF THE INVENTION

1. Field of the Invention

The present invention relates to a liquid crystal molecule and to a liquid crystal display device and a liquid crystal optical spatial modulation device each using the liquid crystal molecule.

2. Description of the Related Art

In recent years, a liquid crystal display device (LCD) of an active matrix driving type such as a TFT (thin film transistor) has been widely used over the range of from small mobile uses to large television sets.

In the LCD, techniques such as impulse driving have been being adopted, thereby attempting to realize a high response speed. However, it is the actual situation that the LCD is inferior to a plasma display (PDP), a field emission display (FED) and the like in display quality regarding dynamic images due to, for example, dynamic image blur to be caused by a slow response speed of a liquid crystal material itself.

Meanwhile, attempts have also been being made to increase a speed of the current 60 Hz frame rate drive to 120 Hz or 240 Hz (high frame rate drive), thereby enhancing the dynamic image display quality. Though the dynamic image display quality in the LCD partly depends upon the driving system including a TFT, it depends mostly on the response characteristics of the liquid crystal material itself. Namely, the foregoing problem may not radically be solved, and the high frame rate drive may not be realized, unless the liquid crystal material is responsible to a high speed.

In the light of the above, it is the situation that a liquid crystal material which can cope with the high frame rate drive and which can exhibit high-speed response permitting realization of a high dynamic image display quality is keenly demanded.

As a liquid crystal capable of realizing high-speed response, a nematic liquid crystal attended by a flexoelectric effect, a ferroelectric liquid crystal, an antiferroelectric liquid crystal and the like are known. The present inventors have paid attention to an electroclinic effect in a smectic A phase.

The electroclinic effect is a phenomenon in which in a smectic A phase, optical axes of liquid crystal molecules uniaxially aligned (liquid crystal molecule longitudinal axes) are inclined according to an intensity of an impressed electric field (see Garoff, et al., Physical Review Letters, Vol. 38, 1977, page 848). When this type of cell is disposed between orthogonal polarizing plates, a transmitted light quantity according to an angle (tilt angle) formed by an optical axis of the polarizing plate and an optical axis of the liquid crystal is obtained (see the following expression (A)), and a maximum transmittance is obtained at a tilt angle of ±45°.

T/T₀=sin²(2θ)×sin²(nΔnd/λ) (A)

Here, T represents a transmitted light quantity; Tₒ represents an incident liquid quantity; θ represents an angle (tilt angle) formed an optical axis of the polarizing plate and an optical axis of the liquid crystal; Δn represents a birefringence of the liquid crystal; d represents a thickness of the liquid crystal layer; and λrepresents a wavelength of the transmitted light.

Results obtained by calculating the dependency of the transmittance on the tilt angle in case of a retardation (=Δnd) giving a maximum transmittance according to the foregoing expression (A) are shown in FIG. 5.

A response time in the electroclinic effect is very fast as from several μseconds to several tens μseconds. Also, there is a merit that in a low electric field intensity, an inclination angle (tilt angle) of the optical axis is proportional (i.e., voltage modulation of transmitted light is possible). That is, it may be said that this is a display mode which is very suited for the active matrix driving.

However, the tilt angle which has hitherto been revealed in liquid crystal materials is not so large that sufficient optical modulation is not obtainable yet.

As a liquid crystal material displaying a large tilt angle, a material system in which a siloxane is added to a non-chiral end is known. A reason for this may be considered to reside in the fact that such a siloxane has a larger volume than that of usual alkyl chains, and when a flexible functional group is added to a terminal group, a core portion which contributes to the optical modulation becomes easily movable by the action of an electric field. According to Naciri, et al., Chem. Mater., 1995, 7, pages 1397 to 1402, in case of a liquid crystal molecule having a structure in which a siloxane is added to a non-chiral end, a maximum tilt angle of 26° is obtained. However, according to the foregoing expression (A), the transmittance is about 60% at the most. Also, since a nitro group is introduced as a polarizing group, the polarization is large. Thus, such a liquid crystal material is still insufficient in consideration of putting a display device or the like into practical use.

Furthermore, JP-A-2008-150334 discloses a liquid crystal molecule having a structure having an asymmetric carbon atom and having a core portion containing a terminal phenyl group and an organosiloxane at positions opposite to each other interposing the asymmetric carbon atom therebetween.

### SUMMARY OF THE INVENTION

It is desirable to provide a liquid crystal molecule having a large tilt angle in an electroclinic effect and capable of obtaining sufficient optical modulation.

Also, it is desirable to provide a liquid crystal display device and a liquid crystal optical spatial modulation device each using a liquid crystal molecule having a large tilt angle in an electroclinic effect and capable of obtaining sufficient optical modulation.

The present inventors have found that the tilt angle can be further increased by a compound in which an organosilane or organosiloxane structure is added to one of chiral ends having an asymmetric carbon atom, and a terminal phenyl group having a functional group is disposed in the other chiral end and made extensive and intensive investigations on the basis of this finding, leading to accomplishment of the present invention.

According to an embodiment of to the present invention, there is provided a liquid crystal molecule having a structure represented by the following general formula (1).

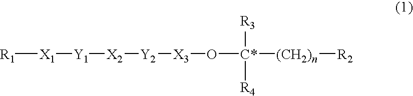

In the general formula (1), X₁ is represented by the following formula (2), and a dangling bond to R₁ is arbitrary.

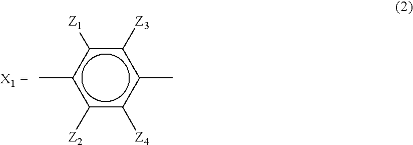

In the general formula (1), X₂ is a group selected among groups represented by the following formula (3).

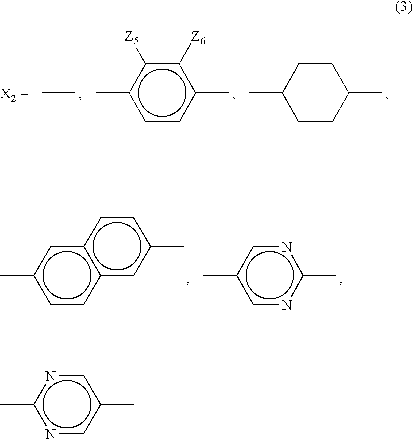

In the general formula (1), X₃ is represented by the following formula (4).

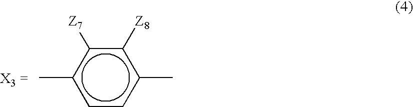

In the formulae (1) to (4), R₁ represents a linear or branched hydrocarbon group or an alkoxy group each having from 4 to 16 carbon atoms; R₂ represents an optionally branched organosiloxane or organosilane having from 1 to 6 silicon atoms; and R₃ and R₄ are different from each other and each represents H, F, Cl, Br, CN, CH₃, CF₃ or OCH₃.

Y₁ and Y₂ each represents -, —COO—, —CH₂—, —CH₂O—, —C₂H₂—, —C₂— or —CF₂O—.

Z₁ and Z₂ each represents F, Cl, Br, OH, NO₂, CN or CF₃; Z₃ and Z₄ each represents H, F, Cl, Br, OH, NO₂, CN or CF₃; Z₅ and Z₆ each represents H, F, Cl, Br, OH, NO₂, CN or CF₃; and Z₇ and Z₈ each represents H, F, Cl, Br, OH, NO₂, CN or CF₃, provided that Z₇ and Z₈ do not represent H at the same time.

n represents an integer of from 1 to 6; * represents a chiral center; and - means a connecting group.

According to another embodiment of the present invention, there is provided a liquid crystal molecule having a structure represented by the following general formula (5).

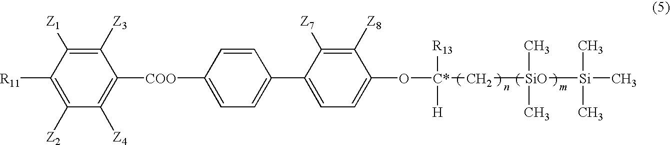

In the formula (5), R₁₁ represents a linear or branched alkoxy group having from 4 to 16 carbon atoms; and R₁₃ represents F, Cl, Br, CN, CH₃, CF₃ or OCH₃.

Z₁ and Z₂ each represents F, Cl, Br, OH, NO₂, CN or CF₃; Z₃ and Z₄ each represents H, F, Cl, Br, OH, NO₂, CN or CF₃; and Z₇ and Z₈ each represents H, F, Cl, Br, OH, NO₂, CN or CF₃, provided that Z₇ and Z₈ do not represent H at the same time.

n represents an integer of from 1 to 6; m represents an integer of from 1 to 5; and * represents a chiral center.

According to a further embodiment of the present invention, there is provided a liquid crystal display device including a pair of transparent substrates; a liquid crystal layer provided between the pair of substrates and having filled therein the liquid crystal molecules according to the embodiment of the present invention which display a smectic A phase where they are uniaxially aligned; and electrodes provided on the substrates, wherein a transmittance of the liquid crystal layer is regulated by inclining a longitudinal axis of the liquid molecular molecules through impression of an electric field on the liquid crystal layer from the electrodes.

According to a yet another embodiment of the present invention, there is provided a liquid crystal optical spatial modulation device including a pair of transparent substrates; a liquid crystal layer provided between the pair of substrates and having filled therein the liquid crystal molecules according to the embodiment of the present invention which display a smectic A phase where they are uniaxially aligned; and electrodes provided on the substrates, wherein spatial modulation regarding light transmitting through the liquid crystal layer is carried out by impressing an electric field on the liquid crystal layer from the electrodes.

The liquid crystal molecule of the embodiment of the present invention displays a smectic A phase as a liquid crystal molecule in a temperature range for use and has a large tilt angle in an electroclinic effect, from which sufficient optical modulation for use in a liquid crystal display device and a liquid crystal optical spatial modulation device is obtainable.

The liquid crystal display device according to the embodiment of the invention is excellent in dynamic image display quality, bright and high in gradation properties and contrast. For example, the liquid crystal display device is applicable to a direct view type LCD or a projection display micro liquid crystal device (for example, LCoS (liquid crystal on silicon) and high-temperature polysilicon TFT-LCD). Also, in particular, it is possible to realize a color display device by field sequential driving using color sequential backlight illumination.

The liquid crystal optical spatial modulation device according to the embodiment of the invention can provide a high-speed optical spatial modulation device capable of achieving three-dimensional display and the like.

### BRIEF DESCRIPTION OF THE DRAWINGS

FIG. 1 is a sectional view showing a configuration of a liquid crystal display device according to an embodiment of the present invention.

FIG. 2 is a diagrammatic view showing a configuration of a liquid crystal optical spatial modulation device according to an embodiment of the present invention.

FIG. 3 is a diagram showing the relationship between a voltage and a tilt angle of an evaluation cell of Example 1.

FIG. 4 is a diagram showing the relationship between a voltage and a tilt angle of an evaluation cell of Comparative Example 1.

FIG. 5 is a diagram showing the relationship between a tilt angle and a transmittance in a liquid crystal cell having aligned uniaxially liquid crystal molecules which display a smectic A phase.

### DESCRIPTION OF THE PREFERRED EMBODIMENTS

### Liquid Crystal Molecule

The liquid crystal molecule according to an embodiment of the present invention is hereunder described.

First of all, the liquid crystal molecule according to an embodiment of the present invention has a structure represented by the following general formula (1).

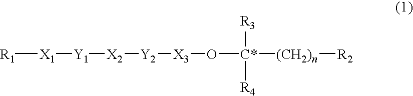

In the general formula (1), X₁ is represented by the following formula (2), and a dangling bond to R₁ is arbitrary.

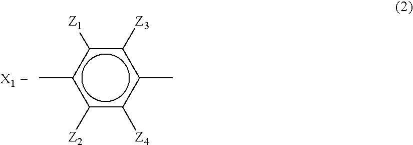

In the general formula (1), X₂ is a group selected among groups represented by the following formula (3).

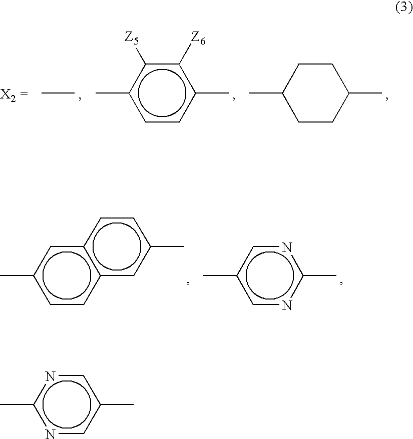

In the general formula (1), X₃ is represented by the following formula (4).

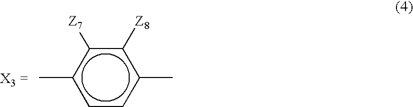

In the formulae (1) to (4), R₁ represents a linear or branched hydrocarbon group or an alkoxy group each having from 4 to 16 carbon atoms; R₂ represents an optionally branched organosiloxane or organosilane having from 1 to 6 silicon atoms; and R₃ and R₄ are different from each other and each represents H, F, Cl, Br, CN, CH₃, CF₃ or OCH₃.

Y₁ and Y₂ each represents -, —COO—, —CH₂—, —CH₂O—, —C₂H₂—, —C₂— or —CF₂O—.

Z₁ and Z₂ each represents F, Cl, Br, OH, NO₂, CN or CF₃; Z₃ and Z₄ each represents H, F, Cl, Br, OH, NO₂, CN or CF₃; Z₅ and Z₆ each represents H, F, Cl, Br, OH, NO₂, CN or CF₃; and Z₇ and Z₈ each represents H, F, Cl, Br, OH, NO₂, CN or CF₃, provided that Z₇ and Z₈ do not represent H at the same time.

n represents an integer of from 1 to 6; * represents a chiral center; and - means a connecting group.

Also, it is more preferable that the liquid crystal molecule according to an embodiment of the present invention has a structure represented by the following general formula (5).

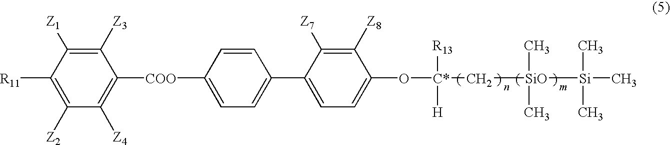

In the formula (5), R₁₁ represents a linear or branched alkoxy group having from 4 to 16 carbon atoms; and R₁₃ represents F, Cl, Br, CN, CH₃, CF₃ or OCH₃.

Z₁ and Z₂ each represents F, Cl, Br, OH, NO₂, CN or CF₃; Z₃ and Z₄ each represents H, F, Cl, Br, OH, NO₂, CN or CF₃; and Z₇ and Z₈ each represents H, F, Cl, Br, OH, NO₂, CN or CF₃, provided that Z₇ and Z₈ do not represent H at the same time.

n represents an integer of from 1 to 6; m represents an integer of from 1 to 5; and * represents a chiral center.

Here, the liquid crystal molecule according to an embodiment of the present invention forms a smectic liquid crystal layer and preferably displays a smectic A phase in a temperature region where a liquid crystal display device or a liquid crystal optical spatial device is used, for example, from 20 to 50° C. The smectic liquid crystal layer is a liquid crystal layer in which the longitudinal axis directions of the liquid crystal molecules are aligned in a layer form (smectic layer). The term “smectic A phase” as referred to herein means that in such a liquid crystal layer, the normal line direction of the liquid crystal layer coincides with the longitudinal axis direction of the liquid crystal molecules.

When such a liquid crystal molecule is used, a tilt angle of 25° or more is revealed due to an electroclinic effect, and the liquid crystal phase shows a transmittance of 60% or more.

### Liquid Crystal Display Device

Next, a configuration of the liquid crystal display device according to an embodiment of the present invention is described. The liquid crystal display device as referred to herein means a so-called direct view type display device such that the display device using a liquid crystal material is viewed directly by a viewer.

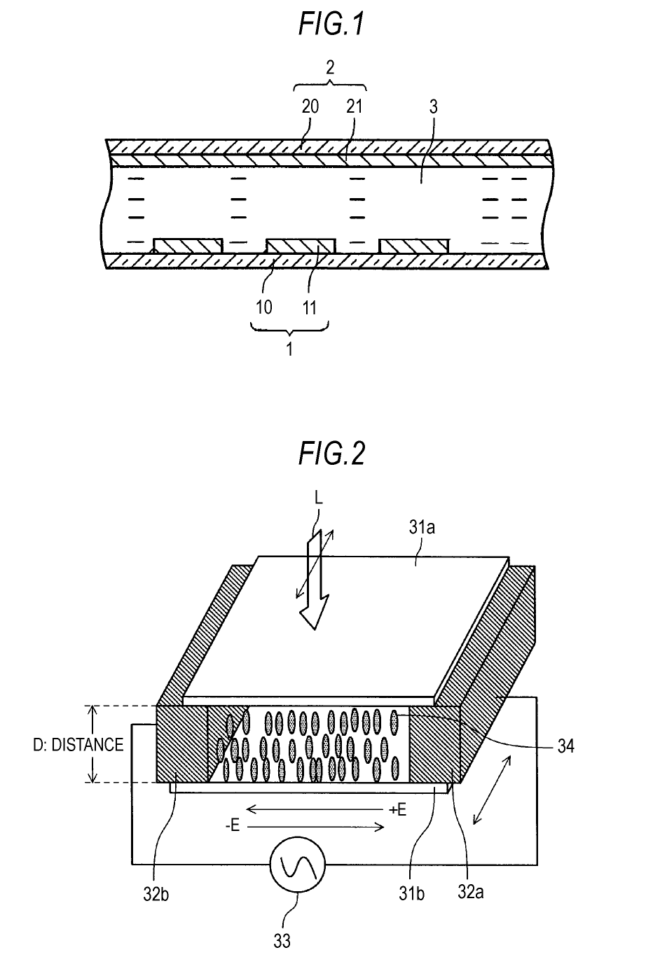

FIG. 1 is a sectional view showing a configuration of the liquid crystal display device according to the embodiment of the present invention. Here, a principal part of a transmission type liquid crystal display device is shown, and an active matrix driving system by thin film transistor (TFT) driving is adopted as a driving system thereof.

As shown in FIG. 1, as a TFT array substrate 1, a TFT for switching is formed for each of a plurality of pixels disposed in a matrix pattern on one surface of a first substrate 10, and a pixel electrode 11 composed of a transparent electrode film connected thereto, such as an ITO film, is configured. Alternatively, a circuit for selecting other pixel or the like may be used in place of the TFT for switching. At that time, a dielectric film may be formed on the pixel electrode 11. Also, as a counter substrate 2, a non-illustrated color filter is formed on one surface of a second substrate 20 as the need arises, and a counter electrode 21 is formed so as to entirely cover them. Furthermore, non-illustrated retardation plates or polarizing plates or the like are formed at necessary locations of the TFT array substrate 1 and the counter substrate 2.

The TFT array substrate 1 and the counter substrate 2 are stuck to each other with a sealing material, and a liquid crystal layer 3 composed of a liquid crystal mixture (liquid crystal material) including the liquid crystal molecule according to the embodiment of the present invention is sealed in a gap between the TFT array substrate 1 and the counter substrate 2 via a non-illustrated alignment film and interposed therebetween. At that time, the liquid crystal molecules according to the embodiment of the present invention display a smectic A phase where the liquid crystal molecules are uniaxially aligned.

In the foregoing liquid crystal display device, a backlight unit such as an LED is provided on the back side. The transmission of light from the backlight unit can be regulated by varying the inclination (tilt angle) of the liquid crystal molecule by a voltage to be impressed between the pixel electrode 11 and the counter electrode 21 (by an electroclinic effect) to control a transmittance. Thus, in the liquid crystal display device according to the embodiment of the present invention, an image with gradation can be displayed.

As for a driving system in relation to an image signal, for example, a 1H reversal driving system (H means a horizontal scanning period) or a 1F reversal driving system (F means a field) or the like can be adopted. In such alternating current driving, the color level (gradation) of the liquid crystal can be varied by a height (magnitude of amplitude) of a driving voltage. In particular, at that time, the contrast of an image to be displayed can be further increased by increasing the driving voltage.

In the liquid crystal display device according to the embodiment of the present invention, since the liquid crystal molecule according to the embodiment of the invention is used, it is possible to display an image which is excellent in dynamic image display quality, bright and high in gradation properties and contrast.

### Liquid Crystal Optical Spatial Modulation Device

Next, a configuration of the liquid crystal optical spatial modulation device according to an embodiment of the present invention is described.

The liquid crystal optical spatial modulation device as referred to herein means a device for planarly splitting light from a light source and varying the intensity, phase or the like of each of the individual light beams thus obtained. This liquid crystal optical spatial modulation device includes a micro-display (LCoS) or light valve used in a projector display, or a phase modulation device such as a light deflection switch. As a specific example of the light valve, the liquid crystal display device shown in FIG. 1 may be applied. That is, light emitted from a light source is separated into red, green and blue rays, the respective color rays are modulated by three light valves, each of which is configured of the liquid crystal display device according to the embodiment of the present invention, and the thus modulated color light beams are again synthesized, thereby achieving enlarged projection on a projection surface.

FIG. 2 shows a configuration example of a light deflection switch as the liquid crystal optical spatial modulation device according to the embodiment of the present invention.

As shown in FIG. 2, a pair of transparent substrates 31a and 31b made of a glass or the like is disposed such that their principal surfaces are made parallel and opposing to each other with a predetermined spacing, and the opposing surfaces are coated with a vertical aligning agent for vertically aligning the liquid crystal molecules. Also, electrodes 32a and 32b are clamped between the transparent substrates 31a and 31b at both ends thereof in one direction, and an alternating current field is impressed between the electrodes 32a and 32b from an external driving unit 33 for impressing an alternating current field.

Liquid crystal molecules 34 according to the embodiment of the present invention are sealed between the transparent substrates 31a and 31b. The liquid crystal molecules 34 display a smectic A phase in the use environment for the liquid crystal optical spatial modulation device and are aligned vertically to the principal surfaces of the transparent substrates 31a and 31b in a state where an electric field is not impressed by the action of the vertical aligning agent.

In the liquid crystal optical spatial modulation device, an incident light L is made incident in parallel to the normal line of the substrate (vertically to the substrate) from the side of the substrate 31a. The incident light L is deflected by an electric field to be impressed between the electrodes 32a and 32b into a direction orthogonal to the electric field direction and then emitted. For example, when an electric field E is 0, shifting of the incident light is not generated, whereas when the electric field E is more than 0, the incident light is deflected and shifted into a prescribed direction (+ direction) orthogonal to the electric field direction and then emitted. Also, when the electric field E is less than 0, the incident light is deflected and shifted into a reverse direction (− direction) to the direction in the case where the electric field E is more than 0 and then emitted. Also, a shifting amount thereof can be regulated by the intensity of the electric field.

### EXAMPLES

Embodiments according to the present invention are more specifically described below with reference to the following Examples.

### Example 1

### (1) Synthesis of Liquid Crystal Molecule

A liquid crystal molecule according to an embodiment of the present invention was obtained in the following procedures.

### (Step 1)

After benzoyl chloride was added dropwise to a pyridine solution of 4,4′-biphenol, the mixture was stirred at room temperature overnight, and the obtained deposit was filtered and subjected to column chromatography with a silica gel to obtain an intermediate product 1.

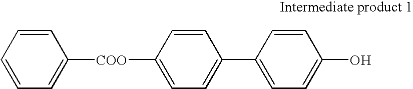

### (Step 2)

The intermediate product 1 was dispersed in acetic acid, nitric acid was added dropwise to the dispersion while keeping it at 15° C., and water was further added thereto, followed by stirring. The obtained deposit was recrystallized from ethanol/acetic acid to obtain an intermediate product 2.

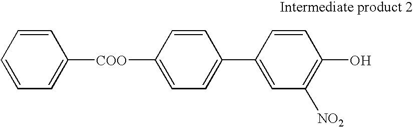

### (Step 3)

An argon-purged flask was charged with the intermediate product 2, triphenylphosphine and a tetrahydrofuran (THF) solution of (S)-5-hexen-2-ol, a THF solution of diethyl azodicarboxylate was added dropwise thereto, and the mixture was stirred at room temperature overnight. After the solvent was evaporated off, the residue was subjected to column chromatography to obtain an intermediate product 3.

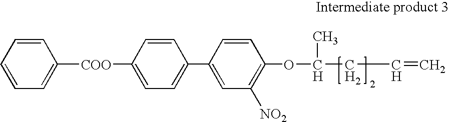

### (Step 4)

A lithium hydroxide aqueous solution was added to a methanol solution of the intermediate product 3, and the mixture was stirred at room temperature overnight. After the solvent was evaporated off, the residue was neutralized with hydrochloric acid, and a desired material was extracted with ethyl ether. Subsequently, after the extract was dehydrated with magnesium sulfate, the solvent was evaporated off, and the residue was subjected to column chromatography to obtain an intermediate product 4.

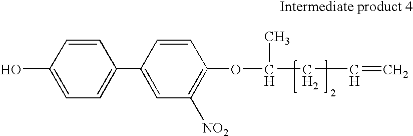

### (Step 5)

The intermediate product 4, 4-dodecaoxy-2,3,5,6-tetrafluorobenzoic acid and a dichloromethane solution of 4-dimethylaminopyridine were added to 1-(3-(dimethylamino)-propyl)-3-ethylcarbodiimide methiodine, and the mixture was stirred at room temperature overnight. Subsequently, the obtained solution was washed with water, subjected to liquid separation and then dried over sodium sulfate. After the solvent was evaporated off, the residue was subjected to column chromatography to obtain an intermediate product 5.

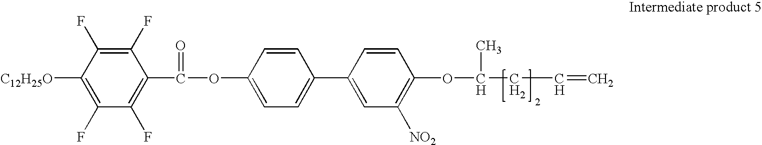

### (Step 6)

Dichloro(dicyclopentadienyl)platinum(II) as a catalyst was added to the intermediate product 5 and a THF solution of 1,1,3,3,3-pentamethyldicyclohexane, and the mixture was stirred in an argon atmosphere at 60° C. for 24 hours. After the solvent was evaporated off, the residue was subjected to column chromatography to obtain a final product 6.

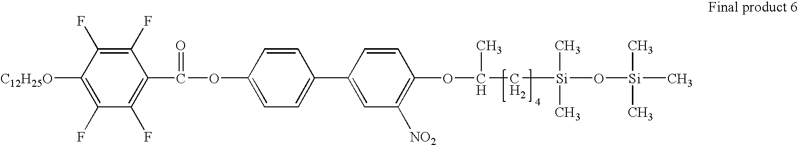

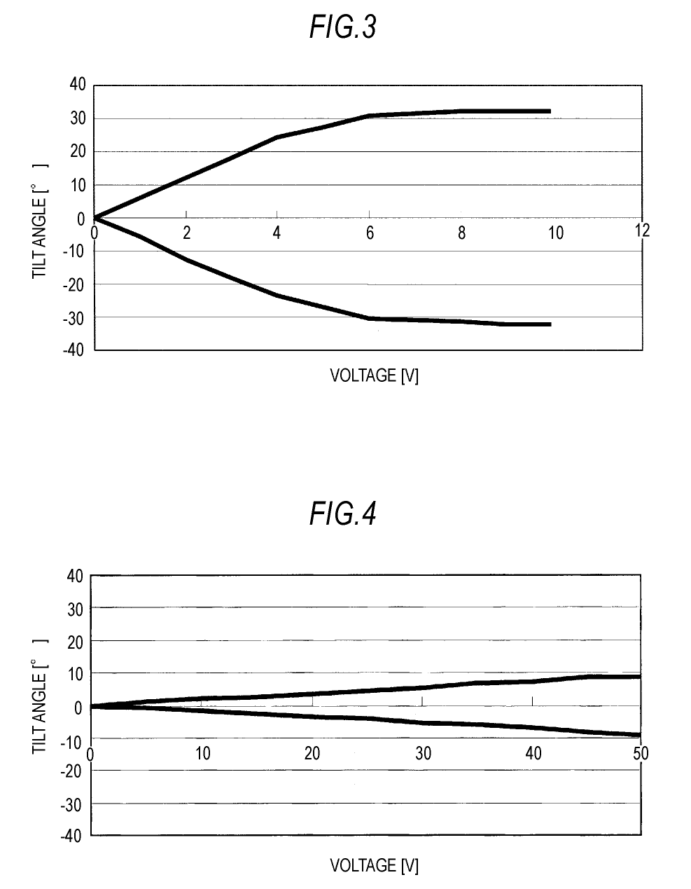

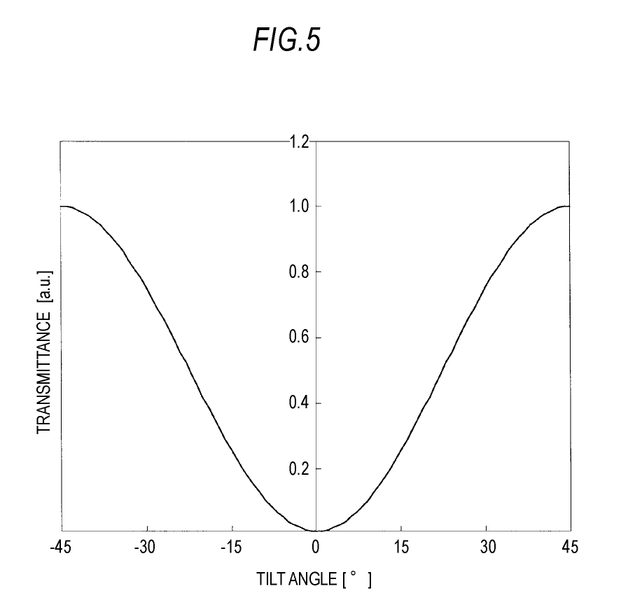

The final product 6 displayed a smectic A phase at from 5° C. to 23° C. The dependency of a tilt angle on the impressed voltage at 10° C. is shown in FIG. 3.

Determination of the phase transition temperature and identification of the smectic A phase were carried out by means of differential scanning calorimetry and polarizing microscope observation with a hot stage.

### (2) Preparation of Evaluation Cell

After a polyimide alignment film was fabricated on a glass substrate provided with ITO (indium tin oxide) and rubbed by a buffed roller, a cell was prepared by use of an ultraviolet ray-curable resin having dispersed therein silica balls with a diameter of 2.4 μm. Subsequently, the liquid crystal molecule (final product 6) synthesized by the foregoing method was poured into the cell at a temperature for promising an isotropic phase, thereby forming an evaluation cell.

### (3) Evaluation of Evaluation Cell

The obtained evaluation cell was evaluated as to a maximum tilt angle, a transmittance and a response time.

As to the tilt angle, the evaluation cell was disposed between orthogonal polarizing plates, a transmitted light quantity was measured while impressing a rectangular wave electric field on the cell, and a half of the angle formed between an optical axis of the polarizing plate and an optical axis of the evaluation cell at which a minimum light quantity was given in positive- and negative-polarity electric fields, respectively was designated as a tilt angle.

Also, as to the transmittance, an optical axis of the evaluation cell at the time of impressing no electric field was set so as to coincide with an optical axis of a polarizing plate of a polarizing microscope, a transmitted light quantity upon impressing an electric field giving a maximum tilt angle was measured by a spectrophotometer, and the transmittance was calculated by taking a value with parallel polarizing plate arrangement as 100%.

Also, as to the response time, the same optical disposition as that for the measurement of a transmittance was used, and a rise time in the case where a voltage was impressed stepwise from a zero electric field so as to give a maximum tilt angle was taken as the response time.

### Comparative Example 1

A liquid crystal molecule corresponding to the comparison was obtained in the following procedures.

### (Step 1)

An argon-purged flask was charged with 4-bromo-2-fluorophenol, triphenylphosphine and a tetrahydrofuran (THF) solution of (S)-5-hexen-2-ol, a THF solution of diethyl azodicarboxylate was added dropwise thereto, and the mixture was stirred at room temperature overnight. After the solvent was evaporated off, the residue was subjected to column chromatography to obtain the following intermediate product 7.

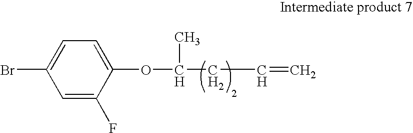

### (Step 2)

Dichloro(dicyclopentadienyl)platinum(II) as a catalyst was added to the intermediate product 7 and a THF solution of 1,1,3,3,3-pentamethyldicyclohexane, and the mixture was stirred in an argon atmosphere at 60° C. for 24 hours. After the solvent was evaporated off, the residue was subjected to column chromatography to obtain an intermediate product 8.

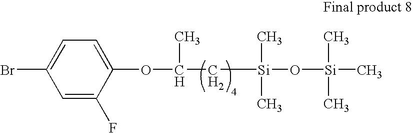

### (Step 3)

Tetrakis(triphenylphosphine)palladium(0) as a catalyst and a sodium carbonate aqueous solution were added to the intermediate product 8 and an ethylene glycol dimethyl ether solution of 4-(4,4,5,5-tetramethyl-1,3,2-dioxaborolan-2-yl)phenol, and the mixture was stirred under a reflux condition in a nitrogen atmosphere for 24 hours. After the solvent was evaporated off, the residue was subjected to column chromatography to obtain an intermediate product 9.

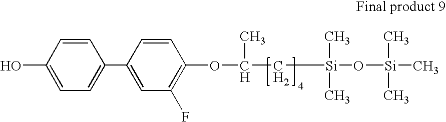

### (Step 4)

The intermediate product 9, 4-dodecaoxybenzoic acid and a dichloromethane solution of 4-dimethylaminopyridine were added to 1-(3-(dimethylamino)-propyl)-3-ethylcarbodiimide methiodine, and the mixture was stirred at room temperature overnight. Subsequently, the solution after stirring was washed with water, subjected to liquid separation and then dried over sodium sulfate. After the solvent was evaporated off, the residue was subjected to column chromatography to obtain a final product 10.

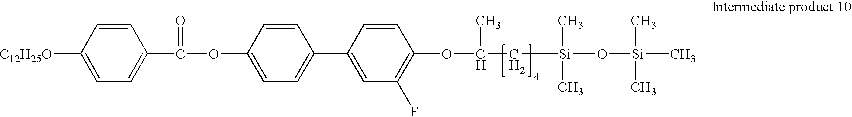

The final product 10 of this Comparative Example 1 displayed a smectic A phase at from 85° C. to 95° C. The dependency of a tilt angle on the impressed voltage at 90° C. is shown in FIG. 4.

Results of the evaluation (measured values of maximum tilt angle, temperature range and response time) of Example 1 and Comparative Example 1 are shown in Table 1.

TABLE 1

| | Example 1 | Comparative Example 1 |
|---|---|---|
| Maximum tilt angle | 32° | 9° |
| Temperature range | 5 to 23° C. | 85 to 95° C. |
| Response time | 80 μseconds | 200 μseconds |

The response time of Comparative Example 1 is on the order of several hundred μseconds, and it may not be said that this response time value is a sufficiently high speed for driving, for example, a 240 Hz frame rate drive (frame time: 4.2 mseconds). On the other hand, the response time of Example 1 is on the order of several tens μseconds, and this response time value was a sufficiently high speed for driving, for example, a 240 Hz frame rate drive.

Also, the maximum tilt angle of Comparative Example 1 is small as 9°. Accordingly, the transmittance was also very small as about 10%. In case of a liquid crystal display device (LCD), power consumption is mostly by backlight, and a liquid crystal material through which only less than a half of the light quantity can transmit produces a serious problem on practical usage. Therefore, the transmittance is very small. On the other hand, in Example 1, the maximum tilt angle was 25° or more, and the corresponding transmittance was 60% or more. As is clear from comparison with Comparative Example 1, the effects were very large.

The present application contains subject matter related to that disclosed in Japanese Priority Patent Application JP 2008-253312 filed in the Japan Patent Office on Sep. 30, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal molecule having a structure represented by the following general formula (1): 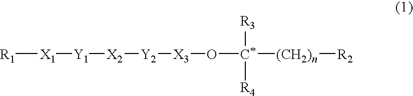
wherein
X₁ is represented by the following formula (2), and a dangling bond to R₁ is arbitrary: 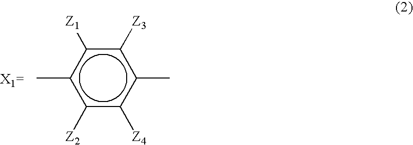
X₂ is a group selected among groups represented by the following formula (3): 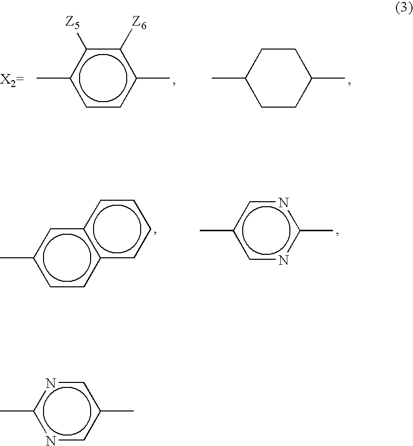
X₃ is represented by the following formula (4): 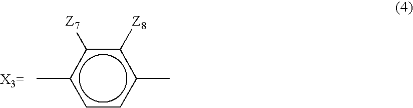
R₁ represents a linear or branched hydrocarbon group or an alkoxy group each having from 4 to 16 carbon atoms;
R₂ represents an optionally branched organosiloxane or organosilane having from 1 to 6 silicon atoms;
R₃ and R₄ are different from each other and each represents H, F, Cl, Br, CN, CH₃, CF₃ or OCH₃;
Y₁ and Y₂ each represents -, —COO—, —CH₂—, —CH₂O—, —C₂H₂—, —C₂— or —CF₂O—;
Z₁ and Z₂ each represents F, Cl, Br, OH, NO₂, CN or CF₃;
Z₃ and Z₄ each represents H, F, Cl, Br, OH, NO₂, CN or CF₃;
Z₅ and Z₆ each represents H, F, Cl, Br, OH, NO₂, CN or CF₃;
Z₇ and Z₈ each represents H, F, Cl, Br, OH, NO₂, CN or CF₃, provided that Z₇ and Z₈ do not represent H at the same time;
n represents an integer of from 1 to 6;
* represents a chiral center; and
- means a connecting group.

2. A liquid crystal molecule having a structure represented by the following general formula (5): 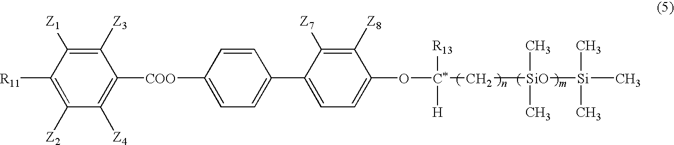
wherein
R₁₁ represents a linear or branched alkoxy group having from 4 to 16 carbon atoms;
R₁₃ represents F, Cl, Br, CN, CH₃, CF₃ or OCH₃;
Z₁ and Z₂ each represents F, Cl, Br, OH, NO₂, CN or CF₃;
Z₃ and Z₄ each represents H, F, Cl, Br, OH, NO₂, CN or CF₃;
Z₇ and Z₈ each represents H, F, Cl, Br, OH, NO₂, CN or CF₃, provided that Z₇ and Z₈ do not represent H at the same time;
n represents an integer of from 1 to 6;
m represents an integer of from 1 to 5; and
* represents a chiral center.

3. A liquid crystal display device comprising:
a pair of transparent substrates;
a liquid crystal layer provided between the pair of substrates and having filled therein the liquid crystal molecules according to claim 1 or 2 which display a smectic A phase where they are uniaxially aligned; and
electrodes provided on the substrates, wherein
a transmittance of the liquid crystal layer is regulated by inclining a longitudinal axis of the liquid molecular molecules through impression of an electric field on the liquid crystal layer from the electrodes.

4. A liquid crystal optical spatial modulation device comprising:
a pair of transparent substrates;
a liquid crystal layer provided between the pair of substrates and having filled therein the liquid crystal molecules according to claim 1 or 2 which display a smectic A phase where they are uniaxially aligned; and
electrodes provided on the substrates, wherein
spatial modulation regarding light transmitting through the liquid crystal layer is carried out by impressing an electric field on the liquid crystal layer from the electrodes.
